(19) United States
(12) Patent Application Publication
(10) Pub. No.: US 2006/0267941 A1
(43) Pub. Date: Nov. 30, 2006

(54) Mouse with one or more additional multifunctional control members

(76) Inventors: Ching-Tzu Chen, Banqiao City (TW); Pi-Yu Chen, Meinong Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/138,336

(22) Filed: May 27, 2005

(51) Int. Cl. G09G 5/08

(52) U.S. Cl. 345/163

(57) ABSTRACT

A mouse with one or more additional multifunctional control members is disclosed. The mouse comprises a main body and at least one control stick, which defines the function of at least one control key/button. In use, a user may use the control stick to enter several commands so as to reach the goal of easy use and control under the windows operating system.

### BACKGROUND OF THE INVENTION

1. Field of the Invention

The invention generally relates to a mouse with one or more additional multifunctional control members. More particularly, the invention relates to a mouse, wherein a control stick is provided on the mouse and such control stick has the functions of several control keys/buttons so as to reach the goal of easy use and control.

2. Description of the Prior Art

As of now, mouse has been a necessary peripheral device of computers. Especially, under the windows operating system, mouse is an indispensable device because it allows more freedom and controllability.

Now, there are different types of mice available on the market and these mice include the traditional track ball mouse, optical mouse and wireless mouse. Several control buttons/keys are provided on a mouse for entering commands under the windows operating system.

In use, a user may move such mouse and press these control buttons/keys to enter commands.

The mice of the prior art have the following disadvantages:
1. In the mice of the prior art, one button/key corresponds to only one button function. If several buttons/keys are to be provided on a mouse, they would take up a lot of space and a user may easily press the wrong button/key.
2. A mouse of the prior art has several buttons/keys and a track ball. In use, a user usually has to use all of his five fingers when he wants to enter several commands; hence, such mouse is difficult to use.

There is another type of mouse available on the market. A small control stick is provided near the buttons. One end of small control stick is connected to the electrical circuit in the mouse, and the other end (upper end) of the small control stick is exposed.

Because the upper end of the small control stick is substantially flush with the buttons, this allows a user may use the buttons and the small control stick simultaneously.

In use, a user may easily press the wrong button or control stick because the buttons and control stick are too close to one another.

To eliminate the disadvantages of the prior art, the inventor has put in many years of effort in the subject and has come up with the mouse of the present invention.

### SUMMARY OF THE INVENTION

The main object of the present invention is to provide a mouse with one or more additional multifunctional control members. A control stick is provided on the mouse and such control stick has the functions of several control keys/buttons so as to reach the goal of easy use and control.

To reach the object, the mouse of the present invention has a main body and at least one control stick, which defines the function of at least one control key/button.

Hence, in use, a user may use the control stick to enter several commands so as to reach the goal of easy use and control under the windows operating system.

### BRIEF DESCRIPTION OF THE DRAWINGS

The drawings disclose several illustrative embodiments of the present invention which serve to exemplify the various advantages and objects hereof, and are as follows:

FIG. 1 is a perspective view of a first embodiment of the present invention.

FIG. 2 is a side view of the first embodiment of the present invention.

FIG. 3 is a perspective view of a second embodiment of the present invention.

FIG. 4 is a perspective view of a third embodiment of the present invention.

FIG. 5 is a side view of the third embodiment of the present invention.

FIG. 6 is a perspective view of a fourth embodiment of the present invention.

### LIST OF REFERENCE NUMERALS

1—Main body
11—Slot
2—Control stick
3—Track ball

### DETAILED DESCRIPTION OF THE PREFERRED EMBODIMENTS

The embodiments of the present invention will be elaborated in the following with reference to the drawings so that the patent review members may easily understand the structure, use and characteristics of the present invention.

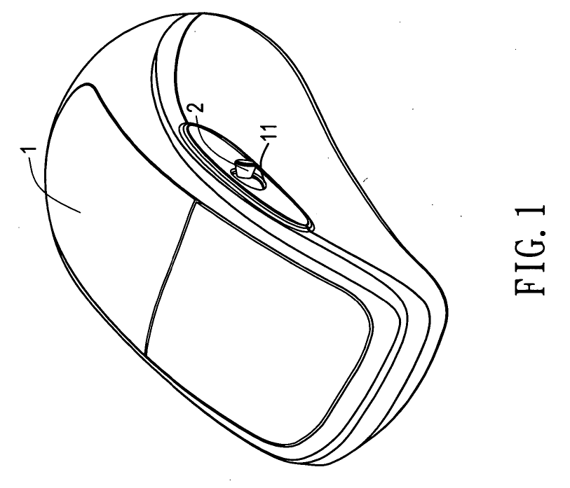

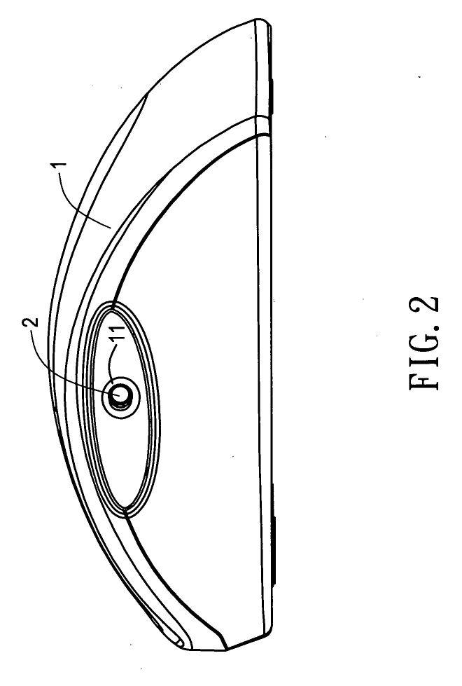

As illustrated in FIG. 1 and FIG. 2, a mouse of the present invention has a main body 1. A slot 11 is provided on a wall of the main body 1. A control stick 2 is disposed within the slot 11. The control stick 2 may be moved around in the slot 11. Each of the front point, rear point, left point and right point of the slot 11 defines the function of a control key, which corresponds to the windows operating system.

In use, a user may hold the mouse and use one of his fingers to move the control stick 2 around to touch any of the front point, rear point, left point and right point of the slot 11 so as to enter commands and to reach the goal of easy control of the windows operating system.

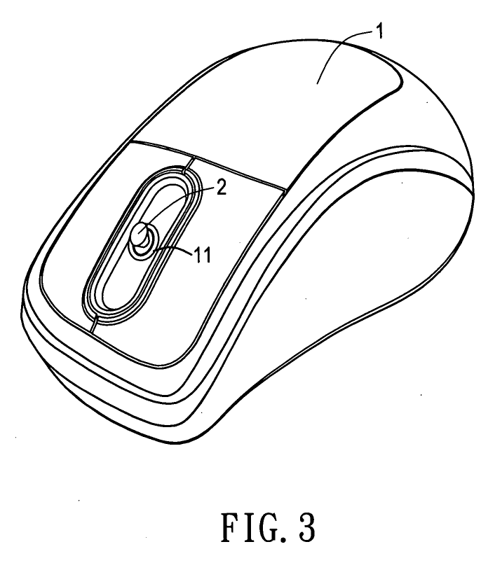

FIG. 3 illustrates a second embodiment of the present invention. In the second embodiment, the control stick 2 is disposed on the upper surface of the main body 1.

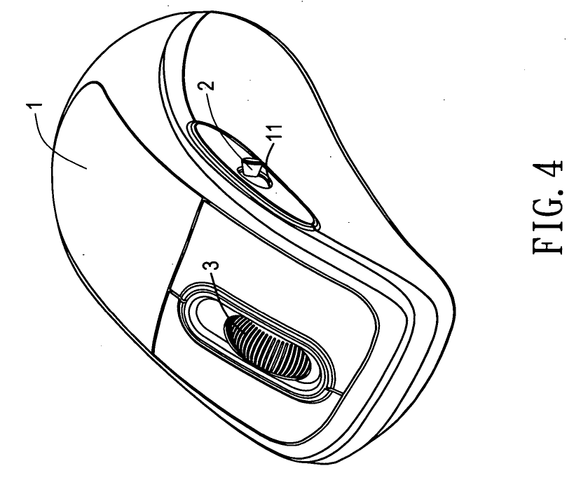

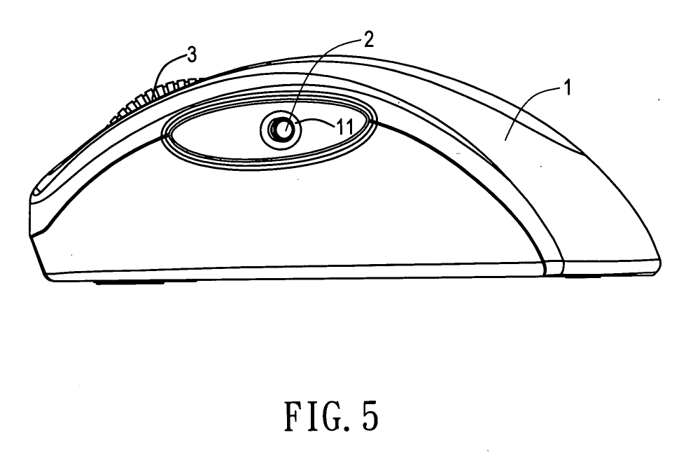

FIGS. 4 and 5 illustrate a third embodiment of the present invention. In the third embodiment, in addition to the control stick 2, a track ball 3 is disposed on the upper surface of the main body 1. The track ball 3 defines at least one control key function.

In the third embodiment, a user may use the control stick 2 and track ball 3 to enter commands under the windows operating system.

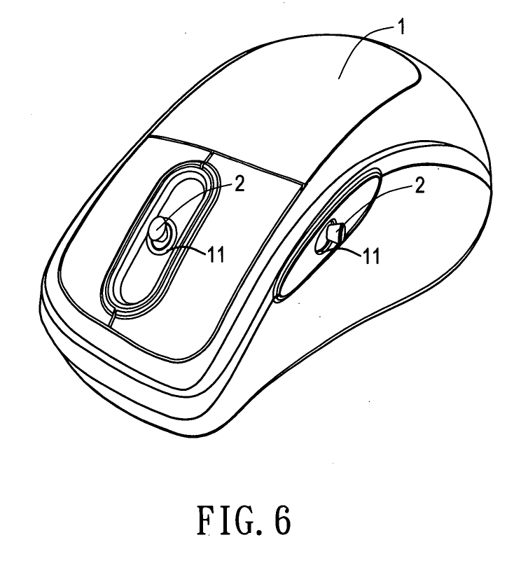

FIG. 6 illustrates a fourth embodiment of the present invention. In the fourth embodiment, two control sticks 2 are disposed on a side wall and the upper surface, respectively, of the main body 1. Each of the front point, rear point, left point and right point of either slot 11 defines the function of a control key, which corresponds to the windows operating system.

From the above, we can see that the present invention has the following advantages:
1. One or more control sticks 2 are used, and each control stick 2 defines the functions of several control keys. Hence, fewer keys are required and the goal of easy control may be attained.
2. A user may use one finger to control a plurality of control keys. In addition, a user may use one hand to enter several commends in an easy, sequential manner.

What hereinbefore described are only the embodiments of the present invention, and these embodiments should not limit the scope of the present invention. Many changes and modifications in the above described embodiments of the invention can, of course, be carried out without departing from the scope thereof.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A mouse with one or more additional multifunctional control members, comprising:
a main body; and
at least one control stick, which defines the function of at least one control key, which corresponds to the windows operating system.

2. The mouse as in claim 1, wherein the control stick is disposed on a wall of the main body.

3. The mouse as in claim 1, wherein the control stick is disposed on the upper surface of the main body.

4. The mouse as in claim 1, wherein each of a plurality of points within the motion range of the control stick defines the function of a control key, which corresponds to the windows operating system.

5. The mouse as in claim 1, wherein each of the front point, rear point, left point and right point within the motion range of the control stick defines the function of a control key, which corresponds to the windows operating system.

6. The mouse as in claim 1, wherein two control sticks are disposed on the main body.

7. The mouse as in claim 6, wherein the two control sticks are disposed on a side wall and the upper surface, respectively, of the main body.

8. The mouse as in claim 1, wherein at least one control stick and at least one track ball are disposed on the main body.

9. The mouse as in claim 8, wherein each of the control stick and track ball defines the function of at least a control key so that a user may use the control stick and track ball to enter commands under the windows operating system.

10. The mouse as in claim 1, wherein a slot is provided on the main body, the control stick is disposed within the slot and the control stick may be moved around in the slot.
